(19) United States
(12) Patent Application Publication
(10) Pub. No.: US 2023/0188932 A1
(43) Pub. Date: Jun. 15, 2023

(54) TECHNIQUE FOR DETERMINATION OF A PASSENGER, AND TICKETING FOR THE PASSENGER IN A PUBLIC TRANSPORT

(71) Applicants: Deendayal Chouhan, Sikar (IN); Shalini Chouhan, Bhopal (IN)

(72) Inventors: Deendayal Chouhan, Sikar (IN); Shalini Chouhan, Bhopal (IN)

(21) Appl. No.: 17/924,383

(22) PCT Filed: May 10, 2021
(86) PCT No.: PCT/IB2021/053957

§ 371 Date: Nov. 10, 2022

(30) Foreign Application Priority Data
May 10, 2020 (IN) 202011017800

(51) Int. Cl. H04W 4/02; G08G 1/052

(52) U.S. Cl. CPC H04W 4/023; G08G 1/052; H04W 4/027

(57) ABSTRACT

A system (1) for determining passenger for a vehicle includes one or more first computing device (2), one or more second computing devices (7), and a third computing device (12) which are being used by passengers, conductors or drivers, and transport service operators or aggregators providing services to transport service operators. The devices (2, 7, 12) cooperates together to process at least one of:
a first location data (4) from the first device (2) and a second location data (10) from the second device (7),
a first location relative location data (8) which is based on signal strength of a second short range signal (6) generated by a second wireless module (11) of the second device (7) and detected by a first wireless module (5) of the first device (2), or combination thereof,

and to determine if user carrying the first computing device (2) is the passenger.

### FIELD OF INVENTION

The invention is related to travelling in a public transport. More specifically the invention is related to determination of a passenger of a public transport vehicle, determination of the distance being travelled by the passenger, ticketing for the distance being travelled, and payment of such ticketing.

### BACKGROUND OF THE INVENTION

Generally, in a public transport system, which includes trains, metros, buses, trams, taxis, auto, etc., a ticket is pre-issued based on a distance being travelled by a passenger, except for unregulated or post-paid taxis/autos. This type of ticketing has inconvenience, and is not dynamic in nature. In some modes of transport, like trains or buses, the passenger has to get in queue, and also has to arrange for cash to get the ticket issued. In furtherance, if he plans not to travel, the cancellation is another headache. Also, the owner of the transport also has to heavily invest on the infrastructure for ticketing, which involves ticket kiosk, Smart card reader, RFID reader etc.

Some of the issues with a traditional ticketing system has been reduced by the introduction of new methods of online booking of tickets, however these are still limited to planned travels, and where reservation is made in advance. They are still less suited for unplanned and unreserved travels. The element of dynamicity is still missing in the ticketing system, which give freedom to the passenger to dynamically choose his travel, and still not be bothered by getting a ticket issued for each of such unplanned travel, and further arranging for payments of each of such tickets. Even the transporter still has to keep a substantial infrastructure at place for issuing, managing, and checking such tickets.

Latest in the line of such technology is to allow cashless payment for city bus travels by using mobile app on passenger's device linked to his ewallets/bank accounts and after boarding the bus, verification of passenger is carried out by scanning a QR code on mobile phone of the passenger. In some mobile applications, passengers have to enter origin and destination stops for fare calculating.

This solution still leaves much to be desired on the front of a dynamicity in travel for a passenger, where the user himself does not have to be bothered about getting the ticket issued, and making a payment. Also, currently the ticket is still issued for a fixed destination, and in case, if the user has to change his destination in between, he cannot do so, once the ticket is issued. No solution is currently available for such dynamic ticketing where the tickets remain open till the time a travel is completed.

### Objective of the Invention

The object of the invention is to provide a mechanism in the transport ecosystem to provide effortless travel for a passenger, with an ease of dynamic ticketing, and payments for the tickets with no or minimum intervention.

### SUMMARY OF THE INVENTION

The object of the invention is achieved by a system for determining a passenger for a vehicle according to claim 1.

The system includes one or more first computing devices used by a first category of the user traveling on the vehicle. The first computing device comprises at least one of a first location determination unit for generating a first location data, or a first wireless module adapted to sense a second short range signal emitted by a second computing device and to generate a first relative location data based on signal strength of the second short range signal, or combination thereof.

The system further includes one or more second computing devices which are either mounted on the vehicle or used by one or more second category of users who are driving the vehicle and/or conducting affairs of the vehicle inside the vehicle. The second computing device includes a second location determination unit which generates a second location data, and a second wireless module which emits the second short range signal bearing a signal source identification at an appropriate strength. The system also includes a third computing device remotely placed with respect to the one or more first computing devices, and the one or more second computing devices. The third computing device includes a third processing unit which receives and processes at least the first location data and the second location data, or the first relative location data, or combination thereof. Based on such processing, the third computing unit determines if the first category of user carrying the first computing device is a passenger of the vehicle.

According to one embodiment of the system, wherein the third processing unit firstly compares the first location data and the second location data, and if the location data are matched or if a distance between the location data is within a distance threshold, then the third processing unit processes the first relative location data, and if such processing of the first relative location data results in presence of the second short range signal with a sufficient strength, then the third processing unit generates a boarding information of the user of the first computing device, wherein the boarding information includes at least one of a boarding location of the boarding, a boarding stoppage referring to name of a scheduled stop of the vehicle where user has boarded, a time of boarding, an identification of the vehicle, an identification of holder of the second device, an identification of service provider owning transport services carried out by the vehicle, a device identification identifying the first computing device, a user identification identifying user of the first computing device, or combination thereof. This embodiment is helpful as it helps in generating the boarding information of the user of the first device. The boarding information is significant data for determination of the passenger.

According to another embodiment of the system, wherein the third processing unit, after generating the boarding information, adapted to process the boarding location of the user of the first device and a route information of the vehicle representative of at least a length of the route of the vehicle for a specific journey, or a stoppage information regarding stoppages for the vehicle, or combination thereof, and generates at least a remaining route length information representative of a part of route remaining to be travelled by the vehicle on the journey, or a remaining stoppage information related to remaining stoppage of the vehicle. In furtherance, the third computing device processes the remaining route length information, or a remaining stoppage information, or a vehicle information regarding identification or categorization of the vehicle, and generates an estimated fare amount regarding a fare for the journey for remaining route of the journey, compares the estimated fare amount to a money information regarding an amount of money available in an electronic account of the user, and if the money information is greater than or equal to the estimated fare amount, then it sends the boarding information to the first computing device, and if the money information is lesser than the estimated fare amount, then it at least generates a deposit alert relating to depositing of additional money to the electronic account, or, a failure notification regarding failure to complete boarding of passenger, or combination thereof, and sends the deposit alert and/or the failure notification to the first computing device. This embodiment is helpful, as it helps in further issuing the boarding ticket only to the passengers who are having sufficient balance in their electronic account or e-wallet. Those who are not having sufficient balance are intimated about failure to issue the ticket and/or regarding depositing an amount in the e-wallet or electronic account.

According to yet another embodiment of the system, wherein the third processing unit, after generating the boarding information, processes the boarding information and at least one of the first location data at a instance, or the second location data at the instance, or combination thereof, determines a distance travelled at the instance, and processes the distance travelled based on a fare rule, determines a running fare at the instance, compares the running fare to a money information regarding an amount of money available in an electronic account of the user, and if a difference between the running fare and the money information is lesser than a money threshold, than sending and advance alert to at least one of the second computing device or the first computing device, wherein the advance alert is related to a notification regarding adding more money to the electronic account. This embodiment is helpful, as it helps in dynamic fare calculation, and in further identifying if the balance in electronic account is sufficient for further journey or not, and in case if the amount is not sufficient then notifying the second computing device and/or the first computing device for depositing of more money for further journey.

According to one embodiment of the system, wherein after sending of the boarding information, the third computing device optionally requests and receives a battery charge information of the first device regarding amount of battery remaining in the first computing device at the time of boarding, or at the time of disabling of communication coupling with the first computing device, processes at least one of the battery charge information, or a traveling history of the user, or combination thereof, and categorizes the user of the first computing device as malicious passenger in case the user makes a deliberate attempt to dodge fare deduction by deliberately disabling communication coupling between the first computing device and the second computing device for an unreasonable period of time. This embodiment is helpful to identify travelers with malicious intentions, who want to dodge charging for their travel.

According to another embodiment of the system, wherein when processing of the first relative location data results in absence of the second short range signal, then the third processing unit compares the first location data and the second location data, and if the location data are mis-matched or if a distance between the location data is outside a distance threshold, then the third processing unit generates a deboarding information of the user of the first computing device, and optionally sends the deboarding information to the first computing device, and optionally processes the deboarding information and to deduct a fare amount for the journey from the electronic account. The deboarding information includes at least one of a deboarding location of deboarding of the user, a deboarding stoppage referring to name of a scheduled stop of the vehicle where user has deboarded, a time of deboarding, the fare amount deducted, the balance amount remaining, the device identification identifying the first computing device, the user identification identifying user of the first computing device, or combination thereof. This embodiment is helpful, as it determines when the passenger ceases his journey, and further deducts the amount on deboarding.

According to yet another embodiment of the system, wherein if a communication coupling between the first computing device and the second computing device is disabled for a time period more than a threshold time period, and optionally if the third computing device receives a disabling information regarding disabling of the communication coupling by the user of the first device, than the third computing device either:
determines the deboarding location to be a last stop of the vehicle on the route of the vehicle, or
after the predefined time period, when the first location data is received, compares the first location data with respect to the route of the vehicle, and determines the deboarding location to be the nearest position or stop on the route of vehicle with respect to the location of the first computing device based on the first location data.

This embodiment is helpful, as it tries to safeguard the travel operators from financial loss, in cases when the first communication device is unexpectedly disabled from communicating further with the third computing device. This shall help to determine the deboarding of the passenger, which can be further used to deduct fare amount from the electronic amount.

According to one embodiment of the system, wherein after generation of the boarding information, the third computing device and the first computing device cooperates together to disable sending of first location data to the third computing device, and thereafter enables sending of the first location data to the third computing device when processing of the first relative location data results in absence of the second short range signal for a predefined period of time. This embodiment is helpful to save battery charge of the first computing device, where the location determining unit of the first computing device can be disabled for a period the first computing device and the second computing device are near to each other. The presumption is that if the first computing device and the second computing device are near to each other, the user of the first computing device shall be in the vehicle which the user of the second computing device is operating or driving. Hence, for this period only proximity of the devices needs to be determined with respect to each other, and location data capturing and sending shall not be required till the period the devices are in proximity.

According to another embodiment of the system, wherein the third processing unit collates at least the boarding information or the deboarding information, or combination thereof at an instance, and generates a passenger data. The passenger data includes at least a number of passengers in the vehicle at the instance, the device identification identifying the first computing device of all the passengers at the instance, the user identification of all the passengers, a biodata of the passengers, a number of passengers deboarded at a previous stoppage, a number of passengers boarded at last stoppage, or combination thereof, and to send the passenger data to the second computing device,

According to yet another embodiment of the system, wherein the second computing device includes a second processing unit, and the second processing unit via the third processing unit or the third processing unit by itself, based on the device identification, sends an audio data and/or visual data to the one or more first computing device and optionally to the second computing device. This embodiment is helpful to provide a mechanism for quick verification of the passengers who shall be having and able to render unique information only sent to the passengers.

According to one embodiment of the system, wherein if either a first location data or the second location data is not available for an instance, the third processing unit extrapolates the location data for the specific time instance, by processing the location data available for other time instances. This embodiment is helpful to keep a location trail for the passengers which may be required for verification or audit, or for any other processing purposes.

According to yet another embodiment of the system, wherein the third processing unit receives and processes a speed of the vehicle, and if the speed of the vehicle is greater than a speed threshold, then the third processing unit at least compares the first location data and the second location data, or process the first relative location data, or combination thereof. This embodiment is helpful, as it reduces false positives while determining the passengers. In traffic situations, when traffic is not moving or moving at a very slow speed, someone who is not a passenger or who is travelling in another vehicle, may also be considered as the passenger of a particular vehicle, as in traffic, he may be co-located with the vehicle and as well as in proximity to second device of the vehicle for a longer period. This may create a situation where the user of the first device may be considered as passenger, when he is not. In such scenarios, considering vehicle speed is also relevant for refining determination of the passenger, and removing false positives. It is to be noted that, it is highly unlikely that two vehicles will move together for a long period with same speed, hence by considering speed data of the vehicle, such false positives can be avoided.

According to one embodiment of the system, wherein the one or more of the first computing devices includes at least one of a first speed unit adapted to determine a first speed data referring to a speed at which the first computing device is moving at a determining instance, a first acceleration unit adapted to determine a first acceleration data referring to an acceleration at which the first device is accelerating at the determining instance, or combination thereof. And, the second computing device includes at least one of a second speed unit adapted to determine a second speed data referring to a speed at which the first computing device is moving at the determining instance, a second acceleration unit adapted to determine a second acceleration data referring to an acceleration at which the second device is accelerating at the determining instance. The third computing device:
processes the first location data received during a determining period of time to generate a first distance data referring to a distance travelled by the user of the first device in the determining period of time,
to process the second location data received during the determining period of time to generate a second distance data referring to a distance travelled by the vehicle in the determining period of time,
to receive and process the first acceleration data during the determining period of time to generate a first rate of change of acceleration data referring to rate of change of acceleration of the first device in the determining period of time,
to receive and process the second acceleration data during the determining period of time to generate a second rate of change of acceleration of the second device in the determining period of time,
to compare at least one of:
   the first speed data and the second speed data,
   the first acceleration data and the second acceleration data,
   the first distance and the second distance, or
   the first rate of change of acceleration, and the second rate of change of acceleration, or combination thereof,
along with comparison of the first location data and the second location data to determine if the first category of user carrying the first computing device is a passenger of the vehicle.

The determining instance is defined as the instance when the third computing device is required to determine whether the user of the first computing device is still traveling in the vehicle or not, and the determining period of time is defined as a time period from boarding of the user or any time after boarding of the user and till the determining instance. This embodiment is helpful, as it further fine tunes mechanism for determining a passenger for a specific time period, and reduce false positives due to further factors being used like, speed of devices, acceleration of devices, change of acceleration of devices, and distance travelled by the devices

According to another embodiment of the system, wherein the first wireless module generates a first list of short range signals available to connect as the first relative location data, and sends the first list of short range signals to the third computing device, and the third processing unit processes the first list of wireless signals to identify presence of the second short range signal in the list. This provides a simple mechanism to verify proximity between the first computing device and the second computing device.

According to yet another embodiment of the system, wherein the first computing device receives a password from a third computing device, and connects to the second computing device through the second short range signal for a predefined time period by using the password, and sends information of such connection to the second short range signal as first relative location data to the third computing device. This further fine tune mechanism to verify proximity between the first computing device and the second computing device, as logging through password in such a way further validates the proximity between specific devices.

According to one embodiment of the system, wherein the third processing unit sends a selection of vehicles to the first computing device based on the first location data, and the first input unit of the first computing device receives a vehicle selection input regarding the vehicle which is selected for traveling, and the third processing unit receives the vehicle selection input, and processes the vehicle selection input along with at least one of the first location data and the second location data, or the first relative location data, or combination thereof. Based on such processing, the third processing unit determines if the first category of user carrying the first computing device is a passenger. This embodiment further fine tunes the passenger determination process, as a user input is received to further validate his presence in the vehicle by his admittance.

According to another embodiment of the system, wherein the third processing unit receives and processes a configuration input related to configuring the one or more second computing device to the vehicle, and to configure the one or more second computing device with the vehicle. This embodiment provides flexibility to replace the second computing device configured to a vehicle, when the second computing device is at fault. In case, the second computing device is the mobile device of the conductor or driver of the vehicle, during change of duty, new conductor's or driver's mobile devices can be configured to the vehicle.

### BRIEF DESCRIPTION OF DRAWINGS

FIG. 1 shows a system for determining passenger of a vehicle, and for ticketing of the travel.

The figures depict embodiments of the disclosure for purposes of illustration only. One skilled in the art will readily recognize from the following description that alternative embodiments illustrated herein may be employed without departing from the principles of the disclosure described herein.

### DETAILED DESCRIPTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more subsystems or elements or structures or components preceded by “comprises . . . a” does not, without more constraints, preclude the existence of other sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.
The technology of the invention is focused to provide following advantages, such as—
   1) The Passenger would not have to scan any code on his mobile or enter origin and destination stops in his/her mobile app. He/she simply has to carry his/her mobile phone.
   2) For passenger verification, new methods will be applied requiring least intervention from the passenger.
   3) It can be used for all modes of public transport travel i.e. bus ridings, metro rails, unreserved train coaches, hired private taxi, auto, shared taxi, auto, if utility service providers agree to use this method.

Embodiments of the present invention will be described below in detail with reference to the accompanying figures.

The invention is envisaged in a setup where multiple transport service providers co-exists and use a system implemented by the invention. Each of the transport service providers shall be running multiple vehicles to transport passengers. Each of the vehicle's affairs may be conducted by a conductor, and each of the vehicle shall be driven by one or more drivers. In furtherance, each of the vehicles shall have multiple passengers at a given instance when the vehicle is on a journey. Each of the passengers can travel on any of the vehicles being run by any of the transport service providers. The system is enabled to determine passengers for any of the vehicles being run by any of the service providers, and can also be enabled to ticket each of such passengers.

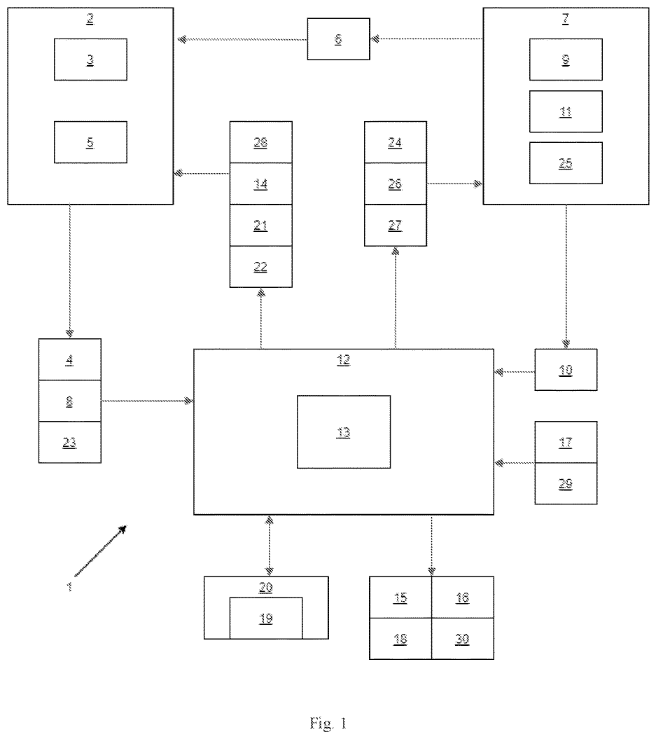

FIG. 1 illustrates a system 1 for determining a passenger of the vehicle. The system 1 includes at least three categories of devices. The first computing devices 2 which should be carried by passengers of the vehicle. The second computing devices 7 which are generally carried by the conductors who are conducting affairs of the vehicle or the drivers of the vehicle, or it can be mounted onto the vehicle. The third computing device 12 can generally be a server which is managed by a travel operator or owner of the transport services owning and managing the vehicle or can be operated by an aggregator providing ticketing solutions to various transport service providers. It is to be noted that the functionality of the second computing device 7 can be performed by one second computing device 7 or more than one second computing device 7 which are available on the vehicle while the vehicle is on the journey.

All the three computing devices, i.e., the first computing device 2, the second computing device 7, and the third computing device 12 are configured to be connected to each other over communication or computer network, like Bluetooth, Mobile networks, Wi-Fi, etc., and are enabled to cooperate and communicate with each other. It is to be noted that there can be more than one first computing devices 2, more than one second computing devices 7, and more than one third computing devices 12 which can cooperate and communicate to each other to enable the implementation of the invention. However, for ease of representation, only one of each of the devices 2, 7, 12 are shown in the figure. In furtherance, some of the computing devices can be portable in nature also, so that a user can carry them along. More specifically, for a feasible implementation of the invention, at least the first computing devices are portable.

The first computing device 2 includes a first location determination unit 3 and a first wireless module 5. The first location determination unit 3 generates a first location data 4. The first wireless module 5 senses a second short range signal 6 emitted by the second computing device 7 and generates a first relative location data 8 based on signal strength of the second short range signal. It is pertinent to be noted that even though the first computing device 2 belongs to one passenger, however, it can be linked to determination for more than one passenger. In such a scenario, the holder of the first computing device 2 has to provide an input to the third computing device regarding the number of passengers travelling along with him/her.

The second computing device 7 includes a second location determination unit 9 and a second wireless module 11. The second location determination unit 9 generates a second location data 10.

While, the second wireless module 11 emits the second short range signal 6 bearing a signal source identification, at appropriate strength. An ideal frequency, bandwidth and strength of shorts range signals emitted shall be such that system 1 is able to determine proximity between emitting device 7 and receiving device 2 to a reasonable accuracy after accounting wave interferences, multi paths etc. in a running vehicle.

Generally, the first computing devices 2 shall be mobile phones of the passenger, and the second computing devices 7 shall be mobile phones of the conductor and/or driver of the vehicle. In some embodiments, the first computing device 2 can be any other portable device which has processing unit, location determination unit, or any other hardware components which are required for implementation of the invention. Similarly, in some embodiments, the second computing device 7 can be any other portable device or devices to be fixed onto the vehicle which has processing unit, location determination unit, or any other hardware components which are required for implementation of the invention.

It is to be noted that all the first computing devices 2, and the second computing devices 7 should have unique identification which is registered with the third computing device 12. Similarly, passengers, conductor, driver, vehicle, location determining units and wireless modules of the computing devices 2, 7 should have unique identification which should be registered with the third computing device 12, and associated with the unique identification of the first computing device 2, or the second computing device 7, as the case may be. While the location data 4, 10, or the first relative location data 8 is being sent to the third computing device 12, unique identification of the devices 2, 7 shall also be sent.

It is pertinent to be noted that the location determination units 3, 9 generate the location data 4, 10 at regular intervals, based on any available technologies like GPS, Wi-Fi, Cell Triangulation, etc. Also, wireless modules 5, 11 are capable of emitting and receiving the short-range wireless signals, continuously based on any available technologies, such as UWB, Wi-Fi, ZigBee, Bluetooth, EnOcean, Wi-SUN, etc.

The third computing device 12 is remotely placed with respect to the first computing device 2, and the second computing device 7. The third computing device 12 includes a third processing 13 unit, which receives and processes the first location data 4 and the second location data 10, and the first relative location data 8, and determines if the first category of user carrying the first computing device 2 is a passenger of the vehicle at a particular instance of time. In an alternate embodiment, the third processing unit 13 may process either the first location data 4 and the second location data 10, or the first relative location data 8, for determining passenger of the vehicle at a particular instance of time. If only the first relative location data 8 is used to determine the passenger, then either the first location data 4 or the second location data 10 generated at the first instance can be used for determining boarding location and either of the location data 4, 10 generated at last instance can be used for determining the deboarding location.

Generally, the third computing device 12 can be a server or cloud server which is managed and operated by owner of the transport service running the vehicle or can be operated by an aggregator providing ticketing solutions to various transport service providers

The third processing unit 13 further processes the location data 4, 10, and the first relative location data 8 to generate a boarding information 14. The third processing unit 13 firstly compares the first location data 4 and the second location data 10. If the location data 4, 10 are matched or if a distance between the location data 4, 10 is within a distance threshold, then the third processing unit 13 processes the first relative location data 8. And, if such processing of the first relative location data 8 results in presence of the second short range signal 6 with a sufficient strength, then the third processing unit 13 generates a boarding information 14 of the user of the first computing device 2. The boarding information 14 includes at least one of a boarding location of the boarding, a boarding stoppage referring to name of a scheduled stop of the vehicle where user has boarded, a time of boarding, an identification of the vehicle, an identification of holder of the second computing device 7, an identification of service provider owning transport services carried out by the vehicle, a device identification identifying the first computing device 2, a user identification identifying user of the first computing device 2, or combination thereof. In one embodiment, the boarding information 14 may be generated by just processing of the location data 4, 10. In yet another embodiment, the boarding information 14 may not be generated at all, rather the purpose of system 1 can just be to verify if the first computing device 2 user was a passenger of the vehicle at a given instance or not.

It is pertinent to note that, while determining the boarding information, finding proximity between two computing devices 2, 7 through location based signals can be indicative only. And, finding the proximity through short range signals can be confirmatory, especially in a vehicle. While deboarding, finding distantness between two devices 2, 7 through short range signals can be indicative only. And, finding the same through location based signals shall be confirmatory. In this way, we can avail benefits of both the methods.

While deboarding, the third processing unit 13 processes the location data 4, 10, and the first relative location data 8 and generates a deboarding information 28. When processing the first relative location data 8 results in absence of the second short range signal 6, then the third processing unit 13 compares the first location data 4 and the second location data 10. And, if the location data 4, 10 are mis-matched or if a distance between the location data 4, 10 is outside a distance threshold, then the third processing unit 13 generates the deboarding information 28 of the user of the first computing device 2. In one scenario, the first computing device 2 suo moto identifies absence of second short range signal, and shall start sending the first location data 4 to the third computing device 12 for further processing. The third processing unit 13 further sends the deboarding information 28 to the first computing device 2. The third processing unit 13 also processes the deboarding information 28 and deducts a fare amount 30 for the journey from the electronic account 19. The third processing unit 13 can also process the boarding information 14 along with the deboarding information 28 to determine the fare amount 30 for the journey. In one embodiment, the deboarding information 28 is not sent to the first computing device 28, rather only information for fare deduction is sent, and the deboarding information is just stored at the server, and the user can retrieve such information whenever it requires. In one specific embodiment, where the tickets are pre-booked or multi journey pass or bus pass or tickets are issued, there is no fare determination or deduction is required, rather the deboarding information is just generated for keeping on records of the third computing device 12 which can be further used for any audits or any analytics purposes. The deboarding information 28 includes at least one of a deboarding location of deboarding of the user, a deboarding stoppage referring to name of a scheduled stop of the vehicle where user has deboarded, a time of deboarding, the fare amount deducted, the balance amount remaining, the device identification identifying the first computing device 2, the user identification identifying user of the first computing device 2, or combination thereof. In one embodiment, the deboarding information 28 may be generated by just processing of the location data 4, 10. In yet another embodiment, the deboarding information 28 may not be generated at all, rather the purpose of system 1 can just be to verify if the first computing device 2 user was a passenger of the vehicle at a given instance or not.

Generally, the boarding location and deboarding location of the passenger shall be determined based on initial location data received and matched for the two devices 2, 7, and the last location data received and matched for the two devices 2, 7, respectively.

While boarding and deboarding, the location data comparison from the first computing device 2, and the second computing device 7 may not result in exact boarding location or deboarding location due to network issues, or the boarding and deboarding may have happened at an unscheduled stop. In such scenario, the third processing unit 13 further processes the route information of the vehicle which shall be having location coordinates of all the stoppages, and compare the location coordinates with the location data from the devices to determine the boarding location or the deboarding location for purpose of ticketing, and fare calculation.

To save battery energy and network congestion, the first computing device 2 may disable generation of the first location data 4 and/or sending it to the third computing device 12 after receipt of the passenger data. The first computing device may further enable generation of the first location data 4 and/or sending it to the third computing device when it detects absence of the second short range signal or receives sufficient input from the accelerometer sensor. Absence of a second short range signal means the passenger has moved out from proximity of the second computing device. Sufficient input from the accelerometer sensor means passenger movement on foot and hence possibly he is out of the vehicle. Additional advantages of such disabling of sending the location data are to reduce false positives which may occur when other vehicles using the system 1 shall be passing near to the vehicle in which the passenger is traveling.

Similarly, after generation of the passenger data for a stoppage, the third computing device may stop comparing the received second location data with any first location data of any first computing device 2, till arrival of the next stoppage or when it finds that the vehicle speed has come to zero, or near zero. It will be helpful in eliminating false positive cases, when other vehicles may be running nearby.

In an alternate embodiment, the communication coupling between the first computing device 2 and the third computing device 12 is not disabled at all during the entire journey, rather it's frequency of sharing location data 4, 10 can be reduced.

In furtherance, the third processing unit 13 collates the boarding information 14 and the deboarding information 28 at an instance, and generates a passenger data 24. The passenger data includes at least a number of passengers in the vehicle at the instance, the device identification identifying the first computing device 2 of all the passengers at the instance, the user identification of all the passengers, a biodata of the passengers, a number of passengers deboarded at a previous stoppage, a number of passengers boarded at the previous stoppage, or combination thereof. The biodata of passenger may also include name, gender, age, photo and last four digits of his/her mobile number to verify identity of first computing device user in case of ambiguity or conflicting situations such as network breakdown, battery discharge, loss of mobile handset or any other unwarranted situation etc. In one embodiment, the third processing unit 13 may just collate the boarding information 14 or the deboarding information 28 at a particular instance, and based on either of them generates the passenger data 24. The third processing unit 13 further sends the passenger data 24 to the second computing device 7. This helps the conductor of the vehicle who shall be holding the second computing device 7 or who shall be having access to the second computing device 7 can further utilize the passenger data 24 to validate the passengers in the vehicle. In case of mismatching of the passengers present and the passenger data, the conductor can issue tickets to the passengers, separately, who are not using services of the system 1.

One way of quick verification or validation of the passengers, can be by sending the valid passenger a visual data 26 and an audio data 27 which can be displayed on their first computing devices 2 for quick verification by the ticket checker/conductor. The visual data 26 and/or the audio data 27 may be sent by the second computing device 7 through the third computing device 12 or directly to the first computing device 2. In another embodiment, the visual data 26 and/or the audio data 27 is procured by the third computing device from its database or can be generated based on certain rules, and which are further broadcasted to the second computing device 7 and the first computing device 2. The audio data can be any tunes or songs, while the visual data can be any video clip, or image or text. The audio/visual data may contain and play/display a periodically changing numerical sequence based on the certain rules. Periodically changing numerical sequence can prevent copying and forwarding such data by one passenger to other passengers for its misuse.

In practice, GPS may not always provide locations at the desired times due to its hardware limitations. In some scenarios, it may happen that either the first location data 4 or the second location data 10 may not be available for certain instances for comparison. In such a scenario, the third processing unit 13 may extrapolate either or both of the location data 4, 10 for the specific time instance, by processing either or both of the location data 4, 10 available for other time instances. This can help in comparing the location data of both the devices more accurately when location of one device is unavailable for the specific time instance, while location of the other device is available.

In one embodiment, the trail of the locations data 4, 10 for multiple instances may not be required, hence such extrapolation may not be required until such trail keeping is not required for an audit purpose. This is relevant in scenarios, when a dispute arises for non-scheduled rides, such as taxi or auto booking where the fare is calculated based on the distance travelled. To resolve such disputes, route taken should be determined, which can only happen when location data 4, 10 is available for various instances during the journey. In case, when a ride is within two locations in a city, and there are multiple routes available to be taken within a city. In such a scenario, location data for every deviation shall be required to determine the route taken.

It is pertinent to be noted that the duties of the conductors and drivers may change and they shall not be allotted the same vehicle. In such scenarios, when the second computing device is owned/operated by either the conductor or the driver, reconfiguration of second devices shall be required for every such change of duties. For such scenarios, the third processing unit 13 is enabled to receive and process a configuration input 29 related to configuring the one or more second computing device 7 to the vehicle, and to further configure the one or more second computing device 7 with the vehicle.

It is pertinent to be noted that using mobile devices of the owner of Autos, and Taxis shall make the solution cost effective for them. The mobile devices of them can be used as second computing devices 7 for implementing the system 1 in their vehicles without requiring further investments from them. Even, the management of the portable devices like mobile phones is easier with respect to vehicle mounted devices.

There are multiple ways possible to reduce false positive while determining the passenger for the vehicle of a public transport. Some of the methodologies are listed below, which can be used in various alternative embodiments.

In one embodiment, the system considers speed of the vehicle to reduce false positive while determining the passenger of the vehicle. This embodiment is particular useful in the scenario where the roads are congested and the vehicles are running side by side for long distances, in such scenario it becomes difficult to determine passenger of the vehicle, as same first computing device 2 shall be co-located with multiple second computing devices 2, as well, these first computing devices 2 shall be in proximity to multiple second computing devices 7. In such a scenario, it becomes very difficult to determine which vehicle the holder of the first computing device 2 shall be passenger to. There can even be the possibility that the holder of the first computing device 2 may not be even a passenger to any of the vehicles, rather he is driving his own vehicle or he may be a passenger in his family-owned car. To handle such scenario, the third processing unit 14 receives and processes a speed of the vehicle, and if the speed of the vehicle is greater than a speed threshold, then the third processing unit 13 compares at least the first location data 4 and the second location data 10, or process the first relative location data 8, or carries out both the processing for determining if the holder of the first computing device 2 is passenger to the vehicle.

Another way to handle false positives is to consider speed of both the devices 2, 7, or distance travelled by both the devices 2, 7, acceleration of both the devices 2, 7, or change in acceleration of both the devices 2, 7, or all of them. The first computing device 2 includes a first speed unit which determines a first speed data referring to a speed at which the first computing device 2 is moving at a determining instance. Similarly, the second computing device 7 includes a second speed unit adapted to determine a second speed data referring to a speed at which the second computing device 7 is moving at the determining instance. The first computing device 2 includes a first acceleration unit which determines a first acceleration data referring to an acceleration at which the first computing device 2 is accelerating at the determining instance. Similarly, the second computing device 7 includes a second acceleration unit which determines a second acceleration data referring to an acceleration at which the second device 7 is accelerating at the determining instance. The third processing unit 13 processes the first location data 4 received during a determining period of time to generate a first distance data referring to a distance travelled by the user of the first computing device 2 in the determining period of time. In furtherance, the third processing unit 13 processes the second location data received during the determining period of time to generate a second distance data referring to a distance travelled by the vehicle in the determining period of time. Also, the third processing unit 13 processes receive and process the first acceleration data during the determining period of time to generate a first rate of change of acceleration data referring to rate of change of acceleration of the first computing device 2 in the determining period of time. The third processing unit 13 receives and processes the second acceleration data during the determining period of time to generate a second rate of change of acceleration of the second computing device 7 in the determining period of time. The determining instance is defined as the instance when the third computing device 12 is required to determine whether the user of the first computing device 2 is still traveling in the vehicle or not. The determining period of time is defined as a time period from boarding of the user or any time after boarding of the user and till the determining instance.

In furtherance, the third processing unit 14 compares the first location data 4 and the second location data 10 along with comparison of at least one of:
the first speed data and the second speed data,
the first acceleration data and the second acceleration data,
the first distance and the second distance, or
the first rate of change of acceleration, and the second rate of change of acceleration, or combination thereof,

And based on such comparisons, the third processing unit 13 determines if the first category of user carrying the first computing device 2 is a passenger of the vehicle.

Yet another way to handle false positives is to get a specific input from the passenger himself regarding if he shall be travelling by a particular vehicle or particular type of vehicle. This shall be especially helpful in scenarios where a lot of congestion is there, and the congestion moves for a long period. In such a scenario, the third processing unit 13 sends a selection of vehicles to the first computing device 2 based on the first location data 4, and the first input unit of the first computing device 2 receives a vehicle selection input regarding the vehicle which is selected for traveling. In furtherance, the third processing unit 13 receives and processes the vehicle selection input along with at least one of the first location data 4 and the second location data 10, or the first relative location data 8, or combination thereof. Based on such processing, the third processing unit 13 determines if the first category of user carrying the first computing device 2 is a passenger.

There are two ways provided for processing of first relative data 8 by the third processing unit 13. In two different embodiments, either of the ways can be used by system 1 for determining the user of the first computing device 2 to be a passenger of the vehicle. The first relative data 8 is based on the phenomenon of proximity of the two devices 2, 7. When two devices are proximate, short range signals emitted by one of the devices 2, 7 shall show up being detected by the other device 2, 7.

In one embodiment, to validate the identity of the second computing device 7, the first wireless module 5 generates a first list of short range signals available to connect. The first computing device in coordination with the third computing device checks the generated first list and validates the second short range signal available, based on its unique identification.

In another embodiment, to validate identity of the second computing device 7, the first computing device 2 receives a password/security code from the third computing device 12, and connects to the second computing device 7 through the second short range signal 6 for a time period, and sends information of such connection to the second short range signal 6 as first relative location data 8 to the third computing device 12. The third computing device 12 after receiving such first relative location data 8 processes it and checks if the connection is rightly established based on the password sent by it.

At the time of boarding, it is desired that the user of the first computing device 2 should have proper funds to carry on his journey. To handle such a scenario, an electronic account 20 is provided which is linked to the user of the first computing device. An advance amount can already be deposited before starting the journey. However, there can be scenarios where the advance put up in the electronic account may not be sufficient to cover the whole journey to be carried by the user. To handle such scenario, for fixed route public transport, the third processing unit 13, after generating the boarding information 14, processes the boarding location of the user of the first device 4 and a route information of the vehicle representative of at least a length of the route of the vehicle for a specific journey, or a stoppage information regarding stoppages for the vehicle, or combination thereof. In furtherance, the third processing unit 13 generates at least a remaining route length information 15 representative of a part of route remaining to be travelled by the vehicle on the journey, or a remaining stoppage information 16 related to remaining stoppage of the vehicle. The third computing device 12 processes the remaining route length information 15, or a remaining stoppage information 16, or a vehicle information 17 regarding identification or categorization of the vehicle, and generates an estimated fare amount 18 regarding a fare for the journey for the remaining route of the journey. The third processing unit 13 further compares the estimated fare amount 18 to a money information 19 regarding an amount of money available in an electronic account 20 of the user, and if the money information 19 is greater than or equal to the estimated fare amount 18, then the third processing unit 13 sends the boarding information 14 to the first computing device 2, and if the money information 19 is lesser than the estimated fare amount 18, then the third processing unit 13 generates a deposit alert 21 relating to depositing of additional money to the electronic account 20 and a failure notification 22 regarding failure to complete boarding of passenger and sends the deposit alert 21 and the failure notification 22 to the first computing device 2.

In scenario, where the route is not fixed, such as Taxi, the third processing unit 13, after generating the boarding information 14, processes the boarding information 14 and at least one of the first location data 4 at an instance, or the second location data 10 at the instance, or combination thereof, and determines a distance travelled at the instance. The third processing unit 13 further processes the distance travelled based on a fare rule and determines a running fare at the instance. The third processing unit further compares the running fare to a money information 19 regarding an amount of money available in the electronic account 20 of the user, and if a difference between the running fare and the money information 19 is lesser than a money threshold, than the third processing unit 13 sends an advance alert to at least one of the second computing device 7 or the first computing device 2. The advance alert is related to a notification regarding adding more money to the electronic account.

The electronic account 20 is linked to the first computing device, and it can be an ewallet, a bank account, credit cards, or a mobile phone operator billing payment, or any other electronic payment mechanism. A minimum fund may be kept in the electronic account 20 as a security fund which can be released only after settling all the pending fare and dues.

It is also to be noted that there can be a scenario where the communication coupling cannot be established between the devices, especially between the first computing device 2 and the third computing device 12, for a long period, and even after the period of completion of journey of the vehicle. In such scenarios, a mechanism for ensuring fare payment to the vehicle owner is required. It is further pertinent to be noted that some cases are genuine cases where the communication is automatically decoupled due to internet failures, low battery charge, etc. In case of such internet failures, the passenger after deboarding from the vehicle can capture a selfie along with the surroundings. Such images captured by first computing device 2 shall also have time stamp and can be stored in a local memory of the first computing device 2, and later on when the communication coupling is established, the selfie captured can be sent along with the time stamp to the third computing device 12 for establishing deboarding information, such as the deboarding location, deboarding time, etc. Another possibility in communication decoupling between the devices 2, 7, an accelerometer of the first computing device 2 shall generate a movement data of the passenger along with timestamp, and store the same in the local memory of the first computing device 2, and when the communication coupling is established, the third processing unit 13 processes the movement data along with time stamp from the first computing device, and that of the second computing device 7 to establish a time of deboarding, and in furtherance the third processing unit 13 shall check the second location data of the second computing device at that specific time frame to determine deboarding information.

It is pertinent to be noted that not all the cases shall be genuine cases, and there can be scenarios, where there are malicious passengers who try to dodge the fare calculations by deliberately decouples communication of his device after receiving the boarding confirmation. In such cases, an advice will be given to the passenger not to disable connectivity of his device especially during the time of boarding and deboarding period. Such advice will be part of the terms & conditions of registration with the system 1 for availing its services by users. In certain scenario, the passenger may not still give any heed to such advice. Accordingly, a proper mechanism should be provided to handle such malicious passengers, so as to safeguard financial interest of the travel operator or owner of the vehicle.

To determine malicious passengers, following embodiment of the system 1 can be used. To determine the malicious passenger, a battery charge information of the first computing device 2, or travel history of the user, or both can be used to determine if the passenger is malicious or not. Travel history helps to identify any malicious acts in the past when the user may have tried to dodge the fare calculation for his travelling. After sending the boarding information 14, the third computing device 12 requests and receives a battery charge information of the first computing device 2 regarding amount of battery remaining in the first computing device 2 at the time of boarding, or at the time of disabling of communication coupling with the first computing device 2. In furtherance, the third processing unit 13 processes at least one of the battery charge information, or a traveling history of the user, or combination thereof, and categorizes the user of the first computing device as malicious passenger in case one makes a deliberate attempt to dodge fare deduction by deliberately disabling communication coupling between the first computing device 2 and the second computing device 7 for an unreasonable period of time.

In one embodiment, if battery charge of the first computing device 2 is low, then the system 1 can be enabled for any of the followings:
The first computing device 2 can be put on power saving mode.
The first computing device 2 may be intimated by the third computing device 12 to feed the destination stop, so that fare can be charged in advance and intimated to the second computing device.
If the passenger had a regular travelling history, then based on his historical travel data, the third processing unit 13 can deduct the fare from the Electronic account 20.

To safeguard interest of travel operator, if a communication coupling between the first computing device 2 and the second computing device 7 is disabled for a time period more than a threshold time period, and if the third computing device 12 receives a disabling information 23 regarding disabling of the communication coupling by the user of the first device 4, than the third computing device 12 conducts the following. In one scenario it determines the deboarding location to be a last stop of the vehicle on the route of the vehicle. This is generally used as a deterrent mechanism for malicious passengers. In another scenario, the third processing unit 13, after the predefined time period, when the first location data 4 is received, compares the first location data 4 with respect to the route of the vehicle, and determines the deboarding location to be the nearest position or stop on the route of vehicle with respect to the location of the first computing device 2 based on the first location data 4,

In certain embodiments, the first location data, and the first relative location data, or any other relevant data to be sent to the third computing device, can be sent to the second computing device through any available network means like Wi-Fi, Bluetooth which are available for connecting both the devices. This embodiment is especially useful, when the communication is decoupled between the first computing device, and the third computing device. Such data received by the second computing device can be further forwarded to the third computing device for further processing.

It is to be noted that any mobile voice/text communication network, internet, Wi-Fi or Bluetooth technology can be used to transmit essential data between different computing devices depending on the availability of technology and suitability of the situation. In one embodiment, the second computing device may execute some or all functions of the third computing device, if any requirement arises so.

Also, it is to be noted that the internet connectivity may not be always required, and is generally required at the time of boarding at least. In due course, any other relevant data can be captured and stored on the devices 2, 7, and can be sent to the third computing device 12 when the network is established to further determine deboarding of the passenger, establishing of the fare amount, determining route taken by the passenger, etc.'

There are available solutions which are not having human intervention for ticketing. However, in the current invention, the focus is not on reducing the human requirements, rather it is for enabling humans, such as conductors and drivers, to efficiently organize their activities which eventually require verifying the total number of passengers in the vehicle, and further verifying the passengers traveling on valid tickets or not. Additionally, another advantage of the current system is to reduce probabilities of incorrect ticketing carried out due to two second computing devices associated with two different vehicles, however co present in one of the either vehicle. Various embodiments are already provided to reduce such false positives. One other way to reduce such a scenario can be by validating the second computing device and its owner by any of the known mechanisms, which can be based on image processing, biometric verification, etc.

### LIST OF REFERENCE SIGNS

1 System
2 First computing device
3 First location determination unit
4 First location data
5 First wireless module
6 Second short range signal
7 Second computing device
8 First relative location data
9 Second location determination unit
10 Second location data
11 Second wireless module
12 Third computing device
13 Third processing unit
14 Boarding information
15 Remaining route length information
16 Remaining stoppage information
17 Vehicle information
18 Fare amount
19 Money information
20 Electronic account
21 Deposit alert
22 Failure notification
23 Disabling information
24 Passenger data
25 Second processing unit
26 audio data
27 visual data
28 Deboarding information
29 Configuration input
30 Fare amount

1. A system (1) for determining passenger for a vehicle comprising:
- one or more first computing device (2) used by a first category of the user traveling on the vehicle, the first computing device (2) comprises at least one of a first location determination unit (3) adapted to generate a first location data (4), or a first wireless module (5) adapted to sense a second short range signal (6) emitted by a second computing device (7) and to generate a first relative location data (8) based on signal strength of the second short range signal, or combination thereof,
one or more second computing device (7) which are either mounted on the vehicle or used by one or more second category of users who are driving the vehicle and/or conducting affairs of the vehicle inside the vehicle, the second computing device (7) comprises a second location determination unit (9) adapted to generate a second location data (10), and a second wireless module (11) adapted to emit the second short range signal (6) at an appropriate strength bearing a signal source identification,
a third computing device (12) remotely placed with respect to the one or more first computing device (2), and the second computing device (7), the third computing device (12) comprises a third processing (13) unit and adapted to receive and process at least:
the first location data (4) and the second location data (10), or
the first relative location data (8), or
combination thereof,
and based on such processing, the third processing unit (13) is adapted to determine if the first category of user carrying the first computing device (2) is a passenger of the vehicle.

2. The system (1) as claimed in claim 1, wherein the third processing unit (13) is adapted to firstly compare the first location data (4) and the second location data (10), and if the location data (4, 10) are matched or if a distance between the location data (4, 10) is within a distance threshold, then the third processing unit (13) is further adapted to process the first relative location data (8), and if such processing of the first relative location data (8) results in presence of the second short range signal (6) of a sufficient strength, then the third processing unit (13) is adapted to generate a boarding information (14) of the user of the first computing device (2), wherein the boarding information (14) comprises at least one of a boarding location of the boarding, a boarding stoppage referring to name of a scheduled stop of the vehicle where user has boarded, a time of boarding, an identification of the vehicle, an identification of holder of the second computing device (7), an identification of service provider owning transport services carried out by the vehicle, a device identification identifying the first computing device (2), a user identification identifying user of the first computing device (2), or combination thereof

3. The system as claimed in claim 2, the third processing unit (13), after generating the boarding information (14), adapted to
process the boarding location of the user of the first device (4) and a route information of the vehicle representative of at least a length of the route of the vehicle for a specific journey, or a stoppage information regarding stoppages for the vehicle, or combination thereof, and adapted to generate at least a remaining route length information (15) representative of a part of route remaining to be travelled by the vehicle on the journey, or a remaining stoppage information (16) related to remaining stoppage of the vehicle,
wherein the third computing device (12) is adapted to process the remaining route length information (15), or a remaining stoppage information (16), or a vehicle information (17) regarding identification or categorization of the vehicle, to generate an estimated fare amount (18) regarding a fare for the journey for remaining route of the journey, to compare the estimated fare amount (18) to a money information (19) regarding an amount of money available in an electronic account (20) of the user, and if the money information (19) is greater than or equal to the estimated fare amount (18), then sending the boarding information (14) to the first computing device (2), and if the money information (19) is lesser than the estimated fare amount (18), then to at least generate a deposit alert (21) relating to depositing of additional money to the electronic account (20), or, a failure notification (22) regarding failure to complete boarding of passenger, or combination thereof, and sending the deposit alert (21) and/or the failure notification (22) to the first computing device (2).

4. The system (1) as claimed in claim 2, the third processing unit (13), after generating the boarding information (14), adapted to process the boarding information (14) and at least one of the first location data (4) at a instance, or the second location data (10) at the instance, or combination thereof, to determine a distance travelled at the instance, and to process the distance travelled based on a fare rule, to determine a running fare at the instance, to compare the running fare to a money information (19) regarding an amount of money available in an electronic account (20) of the user, and if a difference between the running fare and the money information (19) is lesser than a money threshold, than sending and advance alert to at least one of the second computing device (7) or the first computing device (2), wherein the advance alert is related to a notification regarding adding more money to the electronic account.

5. The system (1) as claimed in claims 2 to wherein after sending of the boarding information (14), the third computing device (12) is adapted to optionally request and receive a battery charge information of the first computing device (2) regarding amount of battery remaining in the first computing device (2) at the time of boarding, or at the time of disabling of communication coupling with the first computing device (2), to process at least one of the battery charge information, or a traveling history of the user, or combination thereof, and to categorize the user of the first computing device as malicious passenger in case one makes a deliberate attempt to dodge fare deduction by deliberately disabling communication coupling between the first computing device (2) and the second computing device (7) for an unreasonable period of time.

6. The system (1) as claimed in claims 1 to 5, wherein when processing of the first relative location data (8) results in absence of the second short range signal (6), then the third processing unit (13) is adapted to compare the first location data (4) and the second location data (10), and if the location data (4, 10) are mis-matched or if a distance between the location data (4, 10) is outside a distance threshold, then the third processing unit (13) is adapted to generate a deboarding information (28) of the user of the first computing device (2), to optionally send the deboarding information (28) to the first computing device (2), and to optionally process the deboarding information (28) and to deduct a fare amount (30) for the journey from the electronic account (19),
wherein the deboarding information (28) comprises at least one of a deboarding location of deboarding of the user, a deboarding stoppage referring to name of a scheduled stop of the vehicle where user has deboarded, a time of deboarding, the fare amount deducted, the balance amount remaining, the device identification identifying the first computing device (2), the user identification identifying user of the first computing device (2), or combination thereof.

7. The system (1) as claimed in claim 6, wherein if a communication coupling between the first computing device (2) and the second computing device (7) is disabled for a time period more than a threshold time period, and optionally if the third computing device (12) receives a disabling information (23) regarding disabling of the communication coupling by the user of the first device (4), than the third computing device (12) is adapted to either:
determine the deboarding location to be a last stop of the vehicle on the route of the vehicle, or
after the predefined time period, when the first location data (4) is received, adapted to compare the first location data (4) with respect to the route of the vehicle, and to determine the deboarding location to be the nearest position or stop on the route of vehicle with respect to the location of the first computing device (2) based on the first location data.

8. The system (1) as claimed in claim 2, wherein after generation of the boarding information (14),
the third computing device (12) and the first computing device (2) cooperates together to disable sending of first location data (4) to the third computing device (12), and thereafter
to enable sending of the first location data (4) to the third computing device (12) when processing of the first relative location data (8) results in absence of the second short range signal (6) for a predefined period of time.

9. The system (1) as claimed in claim 6, wherein the third processing unit (13) is adapted to collate at least the boarding information (14) or the deboarding information (28), or combination thereof at an instance, and to generate a passenger data (24) comprising at least a number of passengers in the vehicle at the instance, the device identification identifying the first computing device (2) of all the passengers at the instance, the user identification of all the passengers, a biodata of the passengers, a number of passengers deboarded at a previous stoppage, a number of passengers boarded at last stoppage, or combination thereof, and to send the passenger data (24) to the second computing device (7).

10. The system (1) as claimed in the claim 9, wherein the second computing device (7) comprises a second processing unit (25), and the second processing unit (25) itself or via the third processing unit (14) or the third processing unit (14) by itself, based on the device identification, is adapted to send an audio data (26) and/or visual data (27) to the one or more first computing device (2) and optionally to the second computing device (7).

11. The system (1) as claimed in claim 1, wherein if either a first location data (4) or the second location data (10) is not available for an instance, the third processing unit (13) is adapted to extrapolate the location data (4, 10) for the specific time instance, by processing the location data (4, 10) available for other time instances.

12. The system (1) as claimed in claim 1, wherein the third processing unit (14) is adapted to receive and process a speed of the vehicle, and if the speed of the vehicle is greater than a speed threshold, then the third processing unit (13) is adapted to at least compare the first location data (4) and the second location data (10), or process the first relative location data (8), or combination thereof

13. The system (1) as claimed in claim 1, wherein the one or more of the first computing devices (2) comprises at least one of a first speed unit adapted to determine a first speed data referring to a speed at which the first computing device (2) is moving at a determining instance, a first acceleration unit adapted to determine a first acceleration data referring to an acceleration at which the first computing device (2) is accelerating at the determining instance, or combination thereof, wherein the second computing device (7) comprises at least one of a second speed unit adapted to determine a second speed data referring to a speed at which the second computing device (7) is moving at the determining instance, a second acceleration unit adapted to determine a second acceleration data referring to an acceleration at which the second device (7) is accelerating at the determining instance, and
wherein the third computing processing unit (13) is adapted
to process the first location data (4) received during a determining period of time to generate a first distance data referring to a distance travelled by the user of the first computing device (2) in the determining period of time,
to process the second location data received during the determining period of time to generate a second distance data referring to a distance travelled by the vehicle in the determining period of time,
to receive and process the first acceleration data during the determining period of time to generate a first rate of change of acceleration data referring to rate of change of acceleration of the first computing device (2) in the determining period of time,
to receive and process the second acceleration data during the determining period of time to generate a second rate of change of acceleration of the second computing device (7) in the determining period of time,
to compare at least one of:
the first speed data and the second speed data,
the first acceleration data and the second acceleration data,
the first distance and the second distance, or
the first rate of change of acceleration, and the second rate of change of acceleration, or combination thereof,
along with comparison of the first location data (4) and the second location data (10) to determine if the first category of user carrying the first computing device (2) is a passenger of the vehicle,
wherein the determining instance is defined as the instance when the third computing device (12) is required to determine whether the user of the first computing device (2) is still traveling in the vehicle or not, and the determining period of time is defined as a time period from boarding of the user or any time after boarding of the user and till the determining instance.

14. The system (1) as claimed in claim 1, wherein the first wireless module (5) is adapted to generate a first list of short range signals available to connect as the first relative location data (8), and to send the first list of short range signals to the third computing device (12), and the third processing unit (13) is adapted to process the first list of wireless signals to identify presence of the second short range signal (6) in the list.

15. The system (1) as claimed in claim 14, wherein the first computing device (2) is adapted to receive a password from the third computing device (12), and adapted to connect to the second computing device (7) through the second short range signal (6) for a time period, and adapted to send information of such connection to the second short range signal (6) as first relative location data (8) to the third computing device (12).

16. The system (1) as claimed in claim 1, wherein the third processing unit (13) is adapted to send a selection of vehicles to the first computing device (2) based on the first location data (4), and the first input unit of the first computing device (2) is adapted to receive a vehicle selection input regarding the vehicle which is selected for traveling, and the third processing unit (13) is adapted to receive the vehicle selection input, and to process the vehicle selection input along with at least one of
the first location data (4) and the second location data (10), or
the first relative location data (8), or combination thereof,
and based on such processing, the third processing unit (13) is adapted to determine if the first category of user carrying the first computing device (2) is a passenger.

17. The system (1) as claimed in the claim 1, wherein the third processing unit (13) is adapted to receive and process a configuration input (29) related to configuring the one or more second computing device (7) to the vehicle, and to configure the one or more second computing device (7) with the vehicle.
